(19) United States
(12) Patent Application Publication
(10) Pub. No.: US 2007/0222180 A1
(43) Pub. Date: Sep. 27, 2007

(54) Wheelchair luggage towing device

(76) Inventor: Shiva Amiri, Richmond Hill (CA)

Correspondence Address: Nasser Ashgriz;Suite 302, 203 College Street, Toronto, ON, M5T 1P9, CA

(21) Appl. No.: 11/723,043

(22) Filed: Mar. 16, 2007

Related U.S. Application Data
(60) Provisional application No. 60/786,103, filed on Mar. 27, 2006.

(51) Int. Cl. A61G 5/10

(52) U.S. Cl. 280/304.1

(57) ABSTRACT

A wheelchair luggage towing device to securely attach a luggage to the back of a wheelchair and pull the luggage along with the wheelchair. The device can be used with wheeled, as well as unwheeled luggage using a wheeled luggage carrier. The device comprises of a single or multiplicity of bars. A single bar is used with wheelchairs which have long vertical bars on their back. In this case, a bar is horizontally connected to the vertical bars at the back of the wheelchair so that a luggage can be secured on it. Two bars are used with wheelchairs which have a horizontal bar at their upper back. In this case, one bar is vertically connected to the horizontal bar and the second bar is connected to the lower end of the horizontal bar. Three bar combination is used with wheelchairs which have two short vertical bars and no horizontal bar. In this case, the first bar is connected horizontally to the vertical bars of the wheelchair. The second bar is connected vertically to the first bar. And the third bar is connected horizontally to the other end of the second bar. In all cases, the luggage is secured on the horizontal bar located close to the ground.

This application claims the benefit of U.S. Provisional Application No. 60/786,103 Filed Mar. 27, 2006

### BACKGROUND

1. Field of Application

It is difficult for disabled persons to carry luggage along with their wheelchair while moving from place to place, be it in airport terminals, in and out of hospitals, nursing homes, etc. Travel is extremely difficult as usually an assistant is required to help move the luggage of the disabled traveller. The luggage of the disabled traveller is handled separately, the traveller cannot move the wheelchair and their luggage together, without the help of another person. This creates dependence on another individual in cases of travel or even simpler day-to-day activities such as going to the hospital, shopping, etc. and thus hinders the disabled individual from carrying out certain activities. Our invention takes out the dependence on another individual so that the disabled wheelchair user can gain a great deal of independence by moving their own luggage along with their wheelchair. This is most convenient at airports where the wheelchair user no longer needs to depend on airport staff to handle their luggage and they can be in charge of it themselves.

2. Description of the Related Art

Other inventions have put the luggage in a large carrier (4,902,029), this makes it inconvenient and difficult to use for a disabled person as the carrier needs to be carried somehow itself before it can carry the luggage. Another invention has put the luggage on the side of the wheelchair (4,611,819). This can result in difficulty during turning and throw off the balance of the wheelchair. Also the attachment is very complicated and difficult to use, as is the carrier mentioned before.

### BRIEF DESCRIPTION OF THE DRAWINGS

FIG. 1—A wheelchair luggage towing device attached to the vertical bars at the back of a wheelchair.

FIG. 2—A wheelchair luggage towing device having attaching means, luggage receiving means, and luggage releasing means.

FIG. 3—A device for wheelchairs with a horizontal bar locating too high to set the luggage on. An adjustable vertical bar is used to adjust the height of the horizontal bar from the ground on which the luggage is set on. (a) Method of connection of the wheelchair, (b) device itself.

FIG. 4—A device for wheelchairs with short vertical bars at the back of the wheelchair.

FIG. 5—A device for towing a luggage. The top horizontal bar is attached onto the already existing vertical bars, the attached vertical bar is adjusted low near the ground, and the wheeled suitcase is attached onto the lower horizontal bar.

FIG. 6—(a) A device for connecting the handle of a luggage to a wheelchair. A horizontal bar is attached between the two vertical bars at the back of the wheelchair. (b) Method of connecting the luggage to the wheelchair.

FIG. 7—A wheel chair towing device and its components.

### DETAILED DESCRIPTION OF THE INVENTION

A method and a device for towing a luggage with a wheelchair is described. The method comprises of connecting the luggage to the back of the wheelchair. If the luggage has wheels, it can roll on the ground. If it does not have wheels, it can be put on a luggage towing carriage, and the carriage is then connected to the wheelchair.

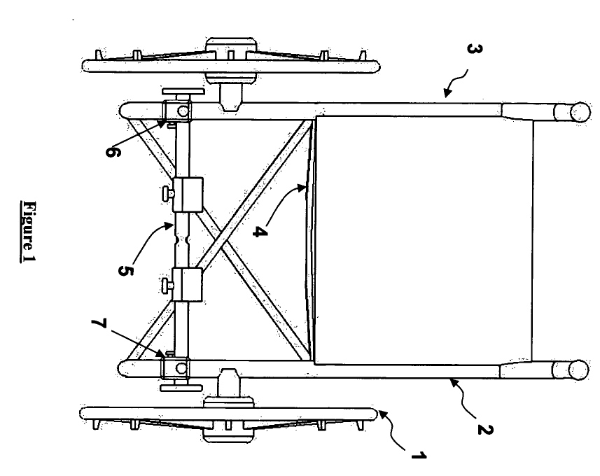

A wheelchair 1 typically consists of two vertical bars, 2 and 3, a foldable chair 4 and several horizontal bars at its back to provide stability and support. In order to carry a luggage along with a wheelchair, a horizontal bar 5 is attached (if one does not already exist) to the two vertical bars 2 and 3 at the back of the wheel chair 1 (all wheelchairs have two vertical bars) using any attachment means, such as 6 and 7 in FIG. 1.

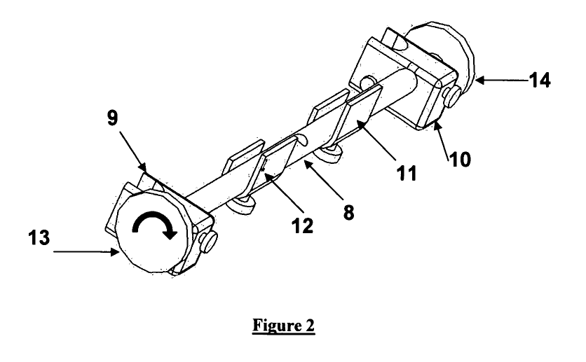

FIG. 2 shows one embodiment of the horizontal bar for towing a luggage. This device is used in wheelchairs which do not have a low lying horizontal bar. A low-lying horizontal bar 8 has attaching means 9 and 10. It also has means to secure a luggage on the bar. Any means, such as two adjustable sockets 11, and 12 can be used to set the luggage on. The wheels of the luggage will fit into sockets 11 and 12 on the horizontal bar or they can be locked or held by any other previously disclosed receiving means on the horizontal bar. The horizontal bar has means for turning the bar 13 and 14 so that it can release the luggage when needed.

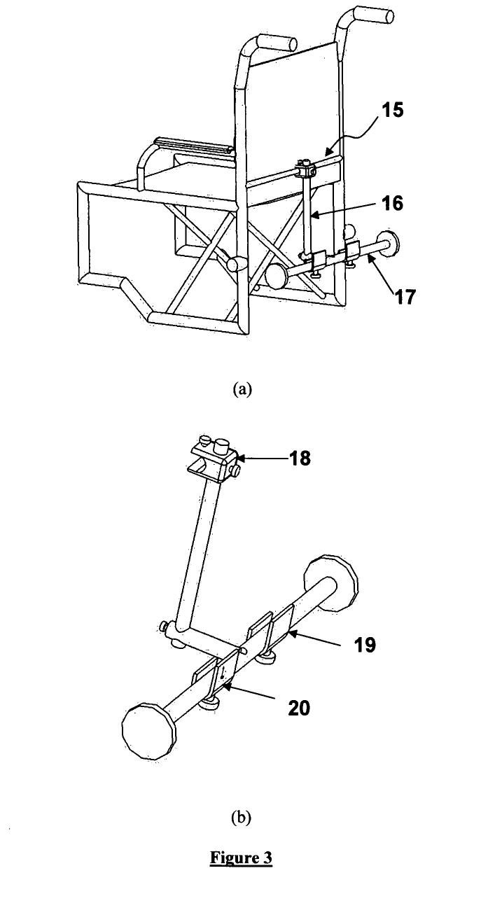

Another embodiment of the present invention is used with wheelchairs which only have a high horizontal bar 15, depicted in FIG. 3. A new vertical bar is then added to the previous embodiment. In this case, the device comprises of an adjustable vertical bar 16, connected to a horizontal bar 17. Then, the vertical bar 16 is attached onto the existing horizontal bar 15, as shown in FIG. 3. This will ensure that the luggage is pulled at a low enough height from the ground so that wheelchair does not flip backwards. FIG. 3b shows the device and its connecting means to the horizontal bar 18 and its luggage receiving means 19 and 20.

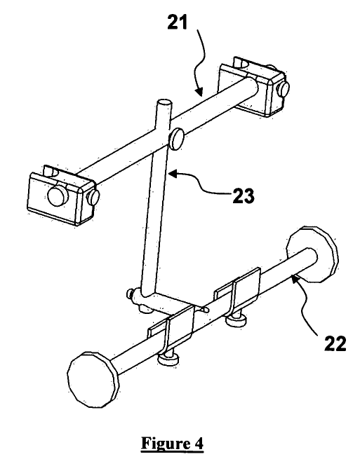

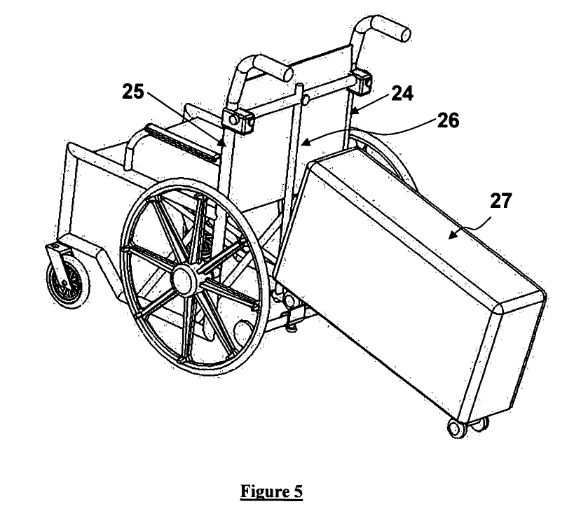

Some wheelchairs do not have long enough vertical bars at their back and they may not even have a horizontal bar. The vertical bars in such wheelchairs do not extend low enough to attach a low lying horizontal bar. Another embodiment of the same device is designed to be used with wheelchairs with short vertical bars. The device, shown in FIG. 4, comprises of two horizontal bars 21 and 22 separated by an adjustable vertical bar 23. The upper horizontal bar 21 is attached onto the wheelchair (See FIG. 5). The top horizontal bar attaches onto the existing vertical bars, 24 and 25. The adjustable vertical bar 26 (attached to the horizontal bars) is adjusted so that the lower horizontal bar locates close to the ground. A luggage 27 attaches onto the lower horizontal bar, at the bottom end of the adjustable vertical bar as shown in FIG. 5.

This device allows for greater stability of the wheelchair as the wheels of the suitcase touching the ground, act as a fifth point of contact (four wheels of the wheelchair and the wheels of the suitcase). Also it is a very simple clamping of the luggage to the wheelchair, as well as being convenient for the user.

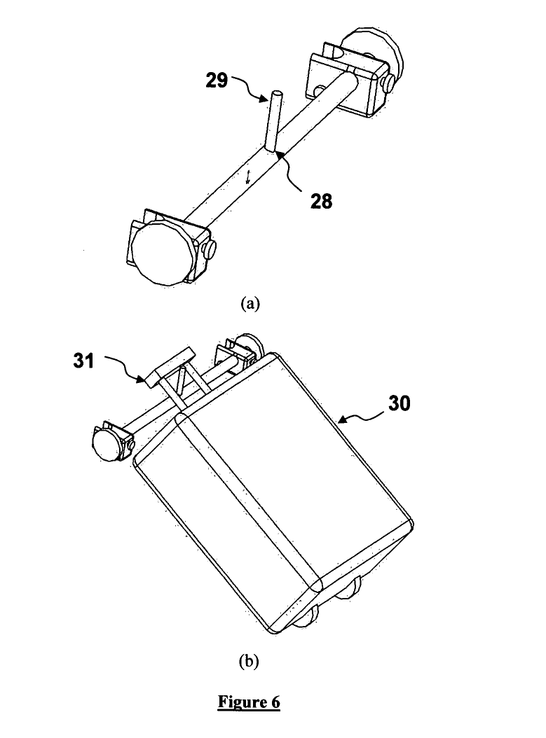

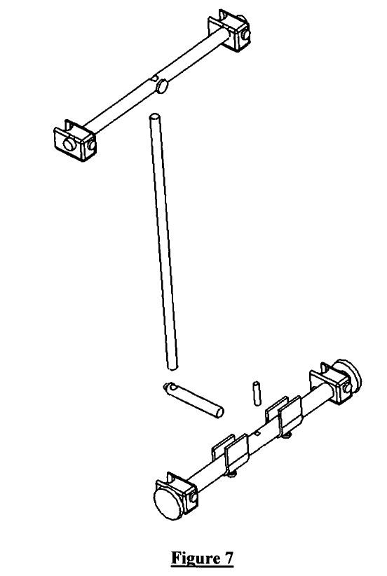

The horizontal bar also includes an aperture at its center 28, in which a small vertical rod 29 can be attached. If suitcase 30 has a handle 31 on its side (closest side to the wheelchair) then this handle can be used as the point of connecting the suitcase to the wheelchair as shown in FIG. 6. FIG. 7 shows all the components of one embodiment of the present device. Various combination of these components can be used with different types of wheelchairs.

Some wheelchairs already have a horizontal bar between the vertical bars at the back, which is low enough to set the luggage on. In this case, the luggage can be directly set and secured onto this existing horizontal bar. If the suitcase does not have wheels, one of the above designs can be used to clamp a wheeled luggage carrier to the wheelchair.

Although certain embodiments of the techniques of the present application have been described, the spirit and scope of the application is by no means restricted to what is described above. Persons having ordinary skill in the art will be able to make variations, permutations, and combinations, in view of the above description, all of which are within the scope of the present application.

Attaching the Bars onto the Wheelchair

The horizontal or vertical or combination bars can be attached onto the wheelchair using any suitable clamping mechanism developed in prior art.

Attaching the Luggage onto the Bars

If suitcase has a handle on the side closest to the wheelchair, the handle could be clamped onto the wheelchair via appropriate clamping mechanism known to the skilled. Clamp can go through the suitcase handle and be attached to vertical bars or horizontal bar.

In another embodiment, clamps could attach onto top wheels of the suitcase (wheels closest to the wheelchair) by any suitable mechanism known to the skilled.

We claim:

1- A wheelchair luggage towing device for wheelchairs having two vertical bars at their back, comprising:
a bar having two ends;
each said end having attaching means to pivotally attach said bar to the vertical bars on the wheelchair; and
said bar having multiplicity of receiving means to securely receive a luggage;
whereby said bar is horizontally attached to the two vertical bars at the back of the wheelchair to receive and carry a luggage.

2- A wheelchair luggage towing device for wheelchairs having two vertical bars at their back and a first horizontal bar connecting said two vertical bars, and said horizontal bar is located closer to the top of the vertical bars, said device comprising:
a vertically extended bar having an upper end and a lower end;
a second horizontally extended bar;
the upper end of said vertically extended bar having adjustable attaching means to vertically attach said bar to the first horizontal bar on the back of the wheelchair;
the lower end of the vertically extended bar having attaching means to connect to the second horizontally extended bar, whereby the second horizontally attached bar located close to the ground; and
the second horizontally extended bar having multiplicity of receiving means to securely receive a luggage.

3- A wheelchair luggage towing device for wheelchairs having two short vertical bars at the back of the wheelchairs, said device comprising:
a first horizontal bar having two ends;
said first horizontal bar having attaching means to attach its ends to the vertical bars on the wheelchair;
a vertical bar having an upper and a lower end;
said vertical bar having adjustable attaching means at its ends;
a second horizontal bar having multiplicity of receiving means to securely receive a luggage;
wherein said first horizontal bar is attached to the two vertical bars at the back of the wheelchair and said vertical bar is attached to the first horizontal bar at its upper end and to the second horizontal bar at its lower end, and the luggage is set on the second horizontal bar.

4- A device of claims 1, 2 or 3, wherein the luggage receiving means are sockets to securely receive the wheels of a wheeled luggage.

5- A device of claims 1, 2 or 3, wherein the luggage receiving means are clamps to attach a wheeled luggage carrier, whereby an unwheeled luggage can be towed by setting them on the luggage carrier.

6- A device of claims 1, 2, or 3, wherein the receiving means comprises of a small rod or a hook, whereby the handle of a luggage can be hooked onto it.

7- A method of towing a wheeled luggage with a wheelchair having a low-laying horizontal bar at its back, method comprising of setting and securing the wheels of the luggage on the low-lying horizontal bar, whereby the luggage can be towed with the wheelchair.
